(19) United States
(12) Patent Application Publication
(10) Pub. No.: US 2013/0000365 A1
(43) Pub. Date: Jan. 3, 2013

(54) Theft Deterrent Enclosure

(76) Inventor: Johnny Edward Walker, Gallatin, TN (US)

(21) Appl. No.: 13/171,175

(22) Filed: Jun. 28, 2011

(51) Int. Cl. E05B 65/52; E05C 19/10; E05C 19/00

(52) U.S. Cl. 70/164; 292/2; 292/95

(57) ABSTRACT

A theft deterrent enclosure that eliminates unauthorized access is disclosed. The enclosure includes a front and back cover. A key lock cylinder is mounted in a lock opening of the front cover such that it blocks the lock opening in a locked position. A keyed interface operates a clamp mounted on a threaded shaft such that the clamp secures the front and hack covers in a closed position. The keyed interface is positioned on an interior side of the enclosure that is opposite and aligned with the lock opening. The theft deterrent enclosure can only he opened from a locked position by engaging the key lock cylinder with a key, removing the key lock cylinder tumbler, inserting the security keyed tool adapted to engage the keyed interface through the lock opening and disengaging the mounting clamp.

This is a Utility patent application filed for the invention by Johnny Edward Walker for a “Theft Deterrent Enclosure”. This application is related to and claims priority from co-pending application Ser. No. 12/759,325 filed Apr. 13, 2010, which claimed priority from co-pending U.S. Provisional Patent Application Ser. No. 61/180,148 filed May 21, 2009, and U.S. Provisional Patent Application Ser. No. 61/359,004 filed Jun. 28, 2010.

### BACKGROUND OF THE INVENTION

1. Field of the Invention

The present invention relates generally to a new and improved tamper resistant enclosure. More particularly, this invention provides an enclosure for a cable service box that is easy for to service personnel, to open and service hut resistant to unauthorized access.

2. Description of the Prior Art

Prior art enclosures for protecting cable boxes and telephone lines have proven deficient in a number of respects. Cable television providers currently face many problems with the theft of components and other cable equipment that are mounted in open areas. In some areas, the theft of these types of components such as power supply boxes is a multi-million dollar industry. Cable providers face even more substantial losses of revenue through increased trouble calls, theft of services, theft of splitters, amplifiers, and signal leakage from cable boxes mounted to the exterior of residences. An unauthorized user may access the cable box of an authorized user and engage in signal splitting or other undesirable tampering. Components such as filters, taps, splitters, fittings and coaxial wire may also be stolen from these cable boxes and result in further losses to the cable provider. Such use not only results in lost revenue for the cable provider, but in addition may alienate the authorized user who endures reduced signal quality or service outages.

Signal leakage also results in adverse safety considerations. The Federal Communications Commission (FCC) and other regulatory agencies have mandated for example that signal leakage be reduced due to the negative effects on emergency communications such as those involving police, fire, aircraft, ham radio, security agencies, television and radio. Signal leakage could possibly disable the communications of safety services or aeronautical navigation systems. Such signal leakage is especially pronounced where not only has cable theft occurred, but the unauthorized users have cut some wires, loosely replaced others, or used cheap after-market splitters.

Enforcement after the fact is difficult for cable providers even though cable theft is a criminal offense in the United States under federal and state law. In theory, the federal Digital Millennium Copyright Act provides particularly stringent regulations against such behavior. However, in many cases, the only evidence left behind of such activities is in the possession of the valid users, and efforts to cut service to those utilizing splitters has an adverse effect on the valid user whose cable box has been accessed. Monitors have been utilized to detect theft and quickly address problems that occur, but these are expensive relative to their benefits.

As a result of the above discussed problems, it is desirable to provide cable housing boxes that prevent entry without detriment to the existing services. Cable providers across the country generally use either pad locks or a round inset lock that can be drilled through or knocked out, such that the lock is merely spinning around in the box and never locking the box itself. The locks also typically use a relatively expensive standardized key that has long since been duplicated to gain entrance to the enclosures. Due to the large number of enclosures and the costs of the locks, providers are reluctant to change the keys often. In addition, the enclosures typically have a housing that is easy to pry open or drill into and, thus, generally easy to break into. This leads to a situation where the enclosures are repeatedly vandalized and their contents accessed. The insecure nature of the prior art enclosures results in increased labor, material, repair and maintenance expenses and a culture of illegal access.

Prior art publications and patents have not addressed the above problems in a satisfactory manner. Many of the existing enclosures require substantial bending of cables entering or exiting the cable box, are difficult for authorized users such as technicians to access, or are prohibitively expensive to manufacture.

Therefore, what is needed is a theft deterrent cable housing box that provides easy access for an authorized user to the inside of the box while minimizing the likelihood of unauthorized access. It would further be desirable for such a device to be of relatively low cost and have easy access for cables passing to and from the box.

### BRIEF SUMMARY OF THE INVENTION

The present invention provides a cable housing device for preventing cable box theft, minimizing signal leakage, reducing trouble calls, and providing an increase in customers. The device includes a double-locking mechanism that is relatively simple for authorized users having the proper tools to access. The device opens such that authorized users can easily work within the device once it is opened. In contrast, unauthorized users are substantially prevented from accessing the interior of the device. The device is of relatively low cost and requires minimal bending of cables entering into the interior of the box. The device is also easily mounted in any location in which such cable housing boxes are usually located.

A preferred embodiment of the present invention is directed toward a theft deterrent enclosure that includes a back mounting assembly having a locking slot. A front cover having a lock opening is adapted to mate with the back mounting assembly. A pair of protrusions on the front cover engage a pair of mating slots on a back mounting assembly of the enclosure when the front cover is positioned over the back mounting assembly. A key lock cylinder is mounted in the lock opening of the front cover such that the key lock cylinder blocks the lock opening when the key lock cylinder is in a locked position. A keyed interface is mounted on the front cover such that the keyed interface can only be accessed through the lock opening when the key lock cylinder is removed from the lock opening. The keyed interface is positioned on an interior of the enclosure opposite and aligned with the lock opening. The keyed interface preferably comprises a threaded shaft with a security keyed screw head. A sleeve guide is positioned inside the enclosure that guides a security keyed tool toward said keyed interface. A mounting clamp is mounted on the front cover that is adapted to engage with the locking slot on the back mounting member by operating the keyed interface to secure the front cover to the back mounting assembly in a closed position. The theft deterrent enclosure can be opened from a locked position by engaging the key lock cylinder with a key, removing the key lock cylinder from the lock opening, inserting a security keyed tool adapted to engage the keyed interface through the lock opening and disengaging the mounting clamp from the locking slot.

### BRIEF DESCRIPTION OF THE SEVERAL VIEWS OF THE DRAWINGS

FIG. 1 is a mechanical drawing of an isometric view from the front of an embodiment of the present invention with the front separated from the back;

FIG. 2 is a mechanical drawing of an isometric view from the front of the embodiment of FIG. 1 with the front and back securely held together by the second locking mechanism;

FIG. 3 is a side view of the embodiment of FIG. 1 with the front separated from the back;

FIG. 4 is a side view of the embodiment of FIG. 1 with the front and back securely held together by the second locking mechanism;

FIG. 5 is a top view of the embodiment of FIG. 1 with the front separated from the hack;

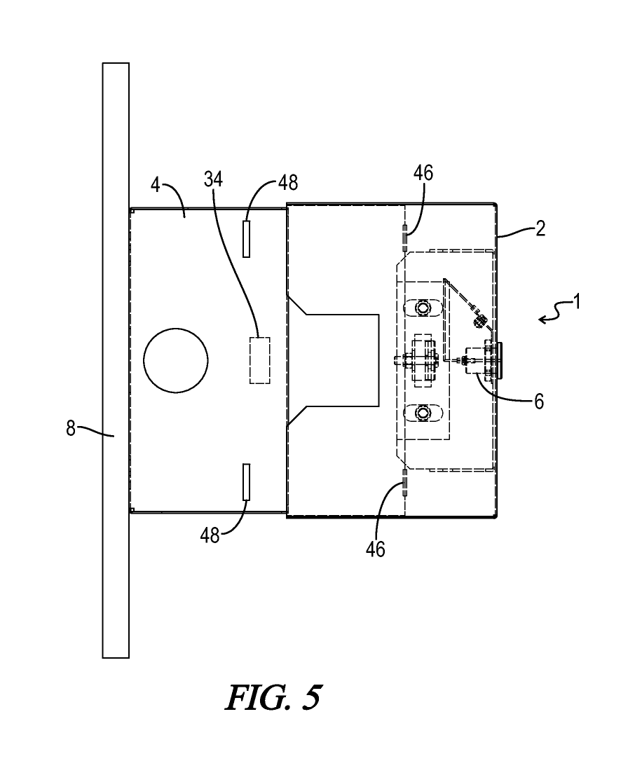

FIG. 6 is a top view of the embodiment of FIG. 1 with the front and back securely held together by the second locking mechanism;

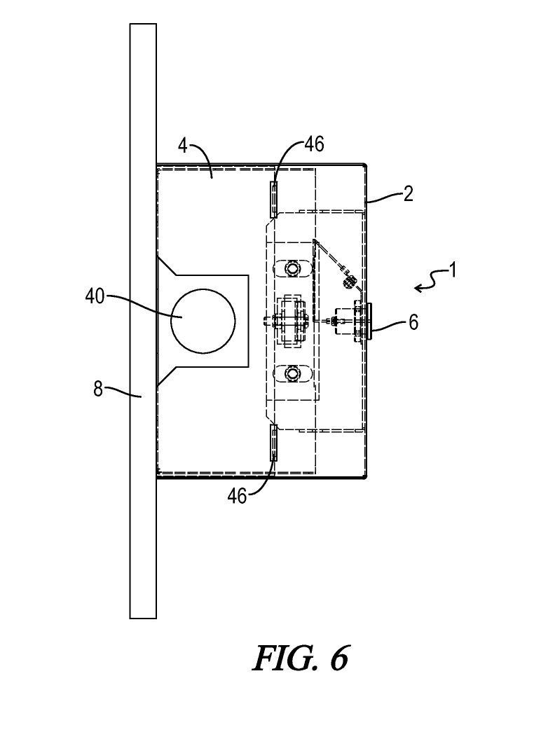

FIG. 7 is an isometric view from the back of the embodiment of FIG. 1 with the front separated from the back;

FIG. 8 is an isometric view from the back of the embodiment of FIG. 1 with the front and back securely held together by the second locking mechanism;

FIG. 9 is a mechanical drawing of the enclosure of FIG. 1;

FIG. 10 is a mechanical drawing of the front cover of FIG. 1;

FIG. 11 is a mechanical drawing of the lock assembly of FIG. 1;

FIG. 12 is an isometric view of an embodiment of the present invention with the second locking mechanism attached to the key lock cylinder;

FIG. 13 is a side view of the embodiment of FIG. 12; and

FIG. 14 is a top view of the embodiment of FIG. 12;

### DETAILED DESCRIPTION OF THE INVENTION

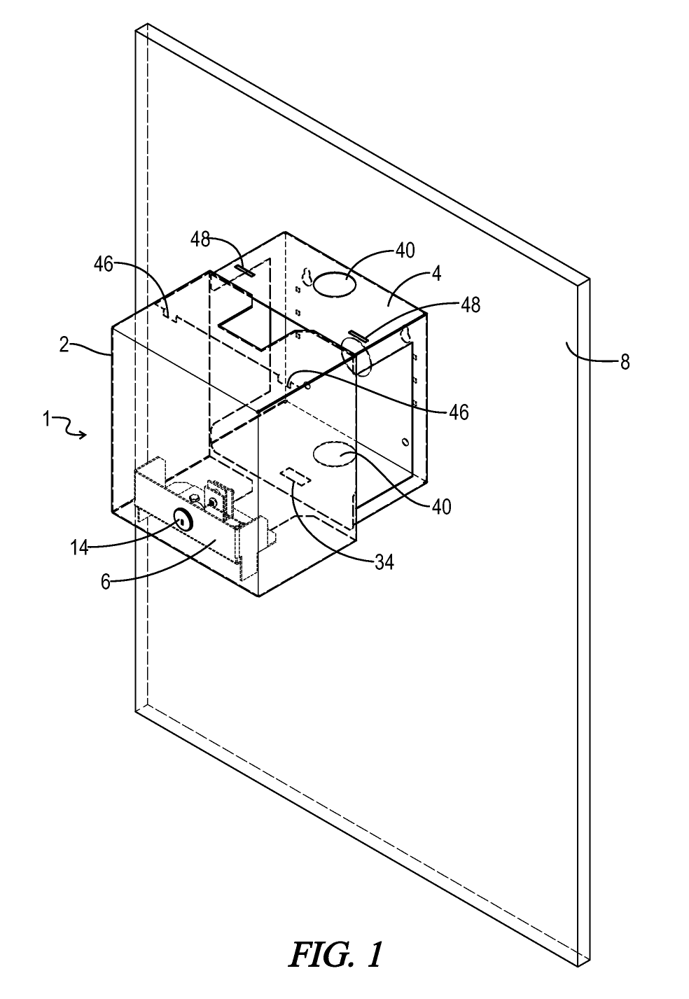

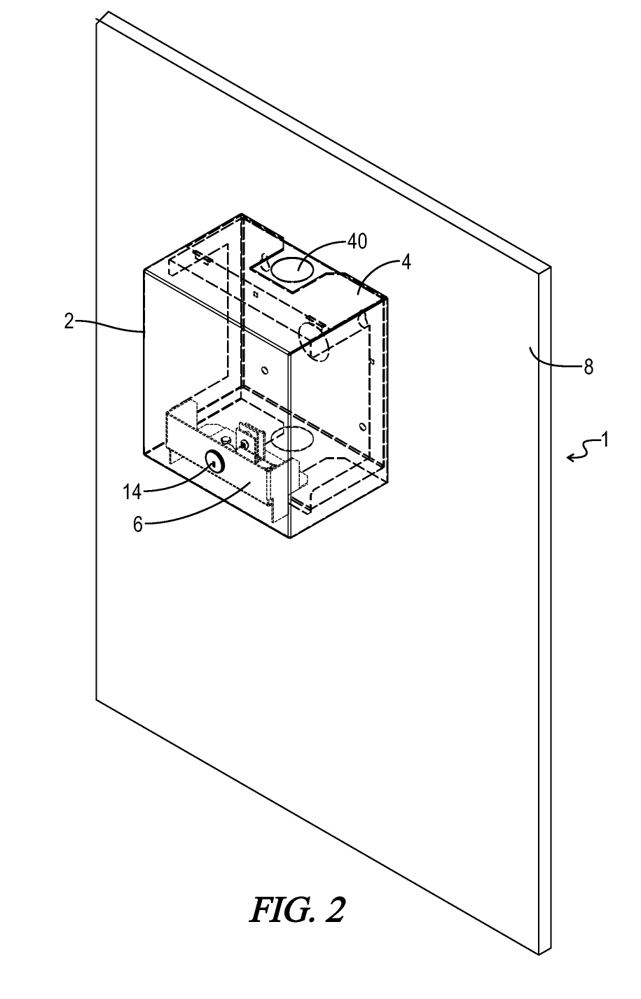

The present invention is directed toward a secure lockbox that uses a two stage locking system to reduce theft of service and unauthorized entry into the lockbox. Referring now to FIG. 1, a mechanical drawing of an isometric view from the front of a preferred embodiment of the present invention, with the front cover 2 separated from the back mounting assembly 4 is shown. The lockbox assembly 1 is preferably constructed by attaching the back mounting assembly 4 to a mounting surface 8 and sliding the front cover 2 over the back mounting plate 4. A pair of metal protrusions 46 on the front cover 2 mate with a pair of slots 48 when the front 2 is positioned over the back 4 to help hold the front cover 2 and back assembly 4 together. A locking assembly 6 having a key lock cylinder 14 mounted on the front cover 2 is then used to secure the front cover 2 to the back mounting assembly 4. FIG. 2 shows the front cover 2 securely mounted on the back mounting assembly 4 by the locking assembly 6. The front cover 2 and back mounting assembly 4 have holes 40 for cable access and the key lock cylinder 14 of the locking assembly 6 as discussed in more detail below.

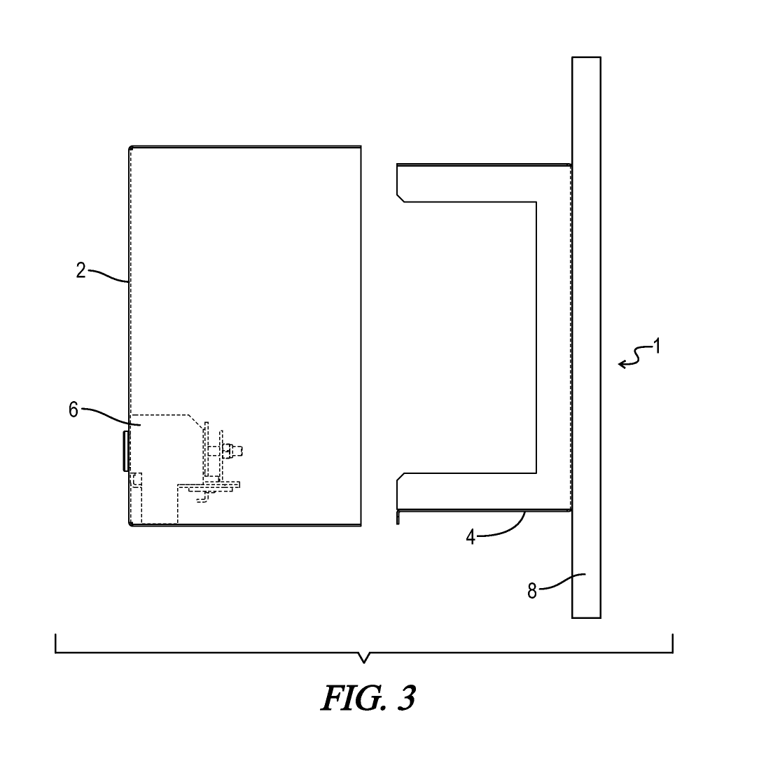

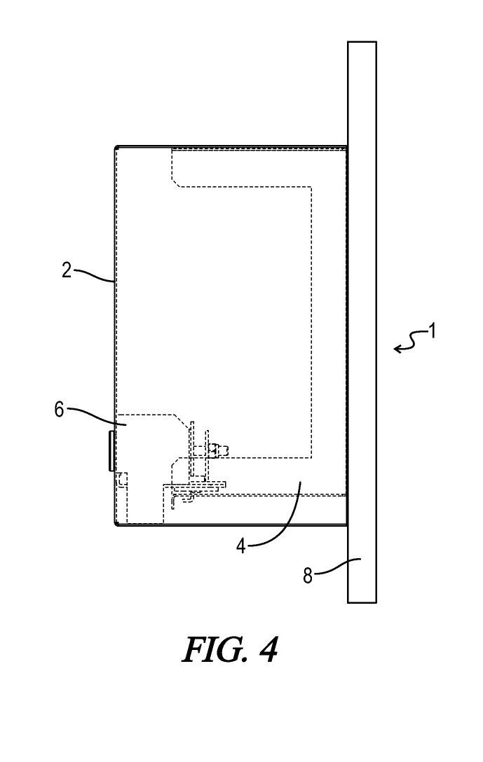

FIG. 3 is a side view of the embodiment of FIG. 1 with the front 2 separated from the back 4 and the locking assembly 6 shown. FIG. 4 is a side view of the embodiment of FIG. 1 with the front 2 and back 4 securely held together by the locking assembly 6.

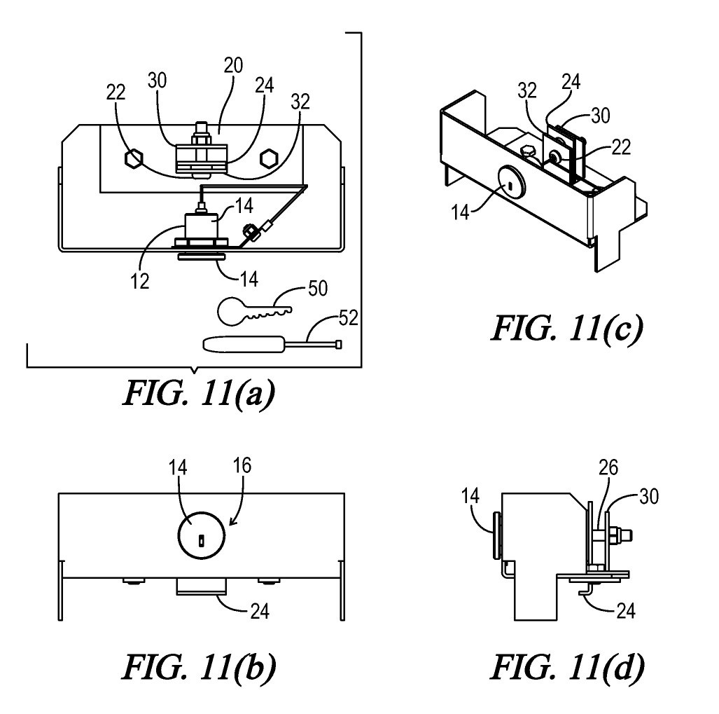

A preferred embodiment of the present invention uses a novel, dual locking system to secure the front cover 2 to the back mounting assembly 4. FIGS. 11(a-d) are mechanical drawings of the top (a), front (b), isometric (c) and side (d) views of the preferred locking assembly 6 of FIG. 1. The locking assembly 6 includes a first locking mechanism 12 with a key lock cylinder 14 that is mounted in a lock opening 42 in the front cover such that a tumbler in the key lock cylinder 14 blocks the lock opening when the tumbler is locked in the key lock cylinder 14. The first locking mechanism 12 is opened by inserting a key 50 in the key lock cylinder 14 and removing the key lock cylinder 14 from the key cylinder opening 16.

The locking assembly 6 also includes a second locking mechanism 20 that can only be accessed when the key lock cylinder 14 of the first locking mechanism 12 is removed from the opening 16. The second locking mechanism 20 includes a keyed interface 22 that is mounted on the second lock mechanism such that the keyed interface 22 engages a mounting clamp 24 held between two fixed plates 30 and 32. The mounting clamp 24 secures the front 2 and back assemblies 4 of the lockbox 1 in a closed position when the keyed interface 22 is engaged with a security keyed tool 52. Turing the keyed interface 22 one way engages the clamp 24 while turning the keyed interface 22 the other way disengages the clamp 24. The security keyed tool 52 may be a standard or Philips head screwdriver or a screwdriver with a custom keyed face. The keyed interface 22 is positioned on the plate 32 an interior side of the lockbox opposite and aligned with the lock opening 16 for the key lock cylinder 14. A sleeve guide may be positioned inside the enclosure, and, in alignment with the lock opening 16 and keyed interface 22, that guides the security keyed tool toward the keyed screw 22 when the keyed tool 52 is inserted through the lock opening 16.

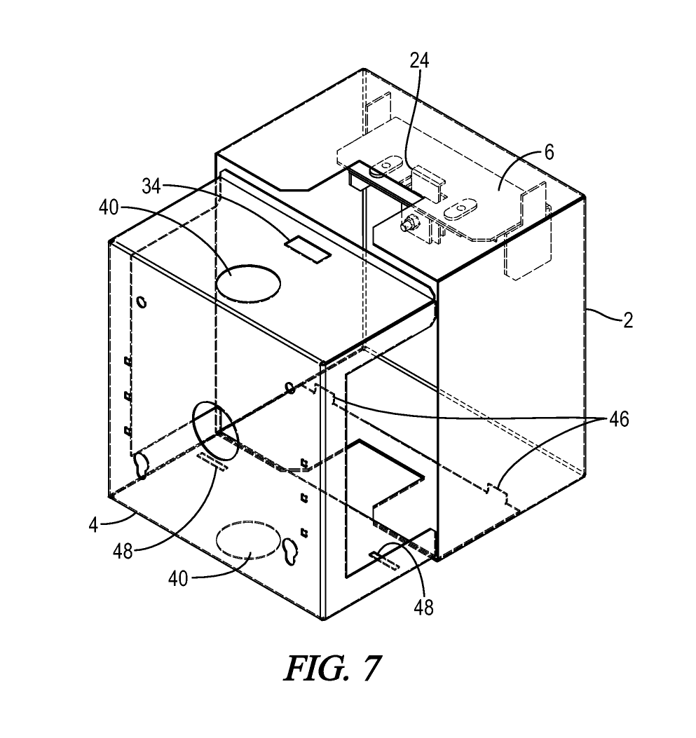

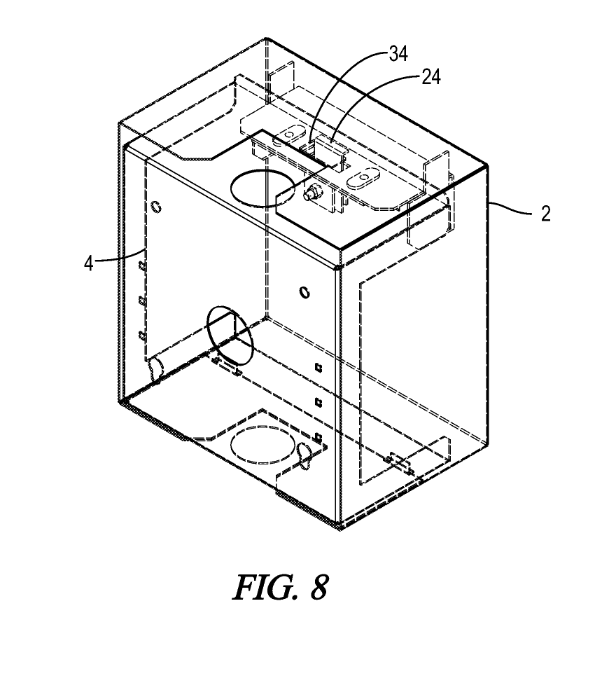

The second lock mechanism 20 includes an L-shaped bracket 24 or mounting clamp that is advanced or retracted on a threaded shaft 26 between two plates 30 and 32 by rotating the keyed interface 22 to engage or disengage a locking slot 34 in the back cover 4. The locking slot 34 is best shown in FIG. 7 which is an isometric view from the bottom and back of the embodiment of FIG. 1 with the front cover 2 separated from the back 4. The locking slot 34 is dimensioned to engage the mounting clamp 24. FIG. 8 is an isometric view from the back of the embodiment of FIG. 1 with the front 2 and back 4 securely held together by the mounting clamp 24 engaging with the locking slot 34. Once the mounting clamp 24 is engaged with the locking slot 34, the front cover cannot be removed from the back mounting assembly 4. In addition, by tightening the clamp 24, the front 2 is held securely against the back 4 so that the entire assembly is firmly held together as a unit.

The use of a mounting clamp 24 in the second locking mechanism allows the construction of a secure lockbox that can be easily opened without the need for a relatively expensive and unreliable hinge. Also, a sufficiently secure lockbox can be created from a much thinner metal (16 gauge) than used in prior art designs using the present construction since portions of the lockbox exterior are formed from two separate reinforcing panels. This is particularly beneficial for cable providers in areas where cost of installation is more of a primary concern, than theft of services. In addition, the double locking feature of the present invention is likely to frustrate potential vandals or thieves that remove the key lock cylinder but cannot determine why the lockbox remains securely held together. Even if the potential thief is able to determine that the second locking mechanism is still securing the lockbox, they are very unlikely to possess the particular security keyed tool required to disengage the second locking mechanism and open the lockbox.

To open the lockbox 1, the key lock cylinder 14 is unlocked and removed. The security keyed tool is then inserted through the lock opening 16 and the keyed screw 22 turned to disengage the mounting clamp 24 from the locking slot 34. The front 2 of the lockbox is then lifted off of and removed from the back cover 4 or base which would typically be mounted on a wall or similar structure 8. Once the front cover 2 has been removed, the interior of the lockbox 1 can be accessed. When the front 2 of the box is placed back on the base 4, there are two metal teeth 46 that fit into slots 48 on the top of the base to help secure the front 2 to the base 4. Engaging the mounting clamp 24 in the locking mechanism forces the front of the box into the structure which the base is attached to and secures the lockbox in a locked position.

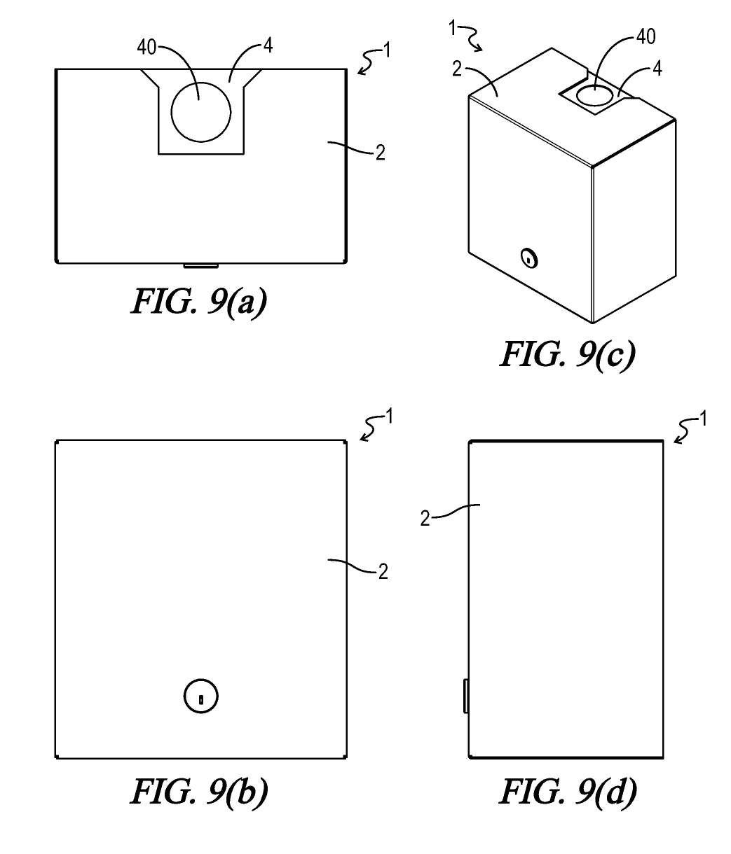

FIG. 9 is a mechanical drawing of the box assembly of FIG. 1 fully assembled. When fully assembled, the key lock cylinder 14 and the access opening 40 are the only features accessible from the exterior of the box 1.

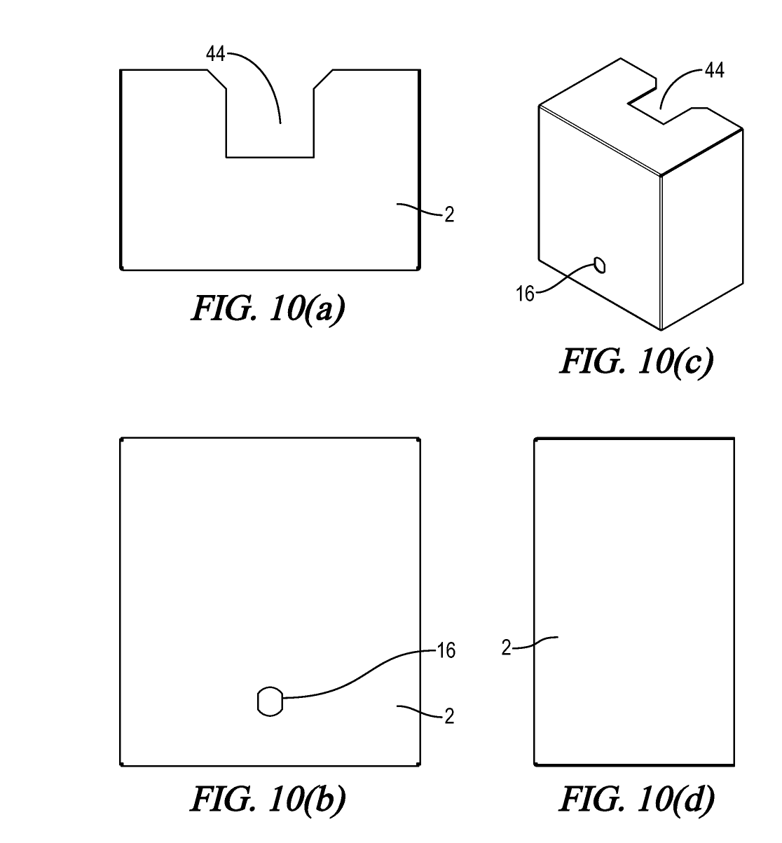

FIG. 10 (a-d) are mechanical drawings of the front cover 2 of FIG. 1 showing the lock opening 16 that receives the key lock cylinder 14. A opening slot 44 on the front cover 2 corresponds with the access opening 40 on the back mounting assembly 4.

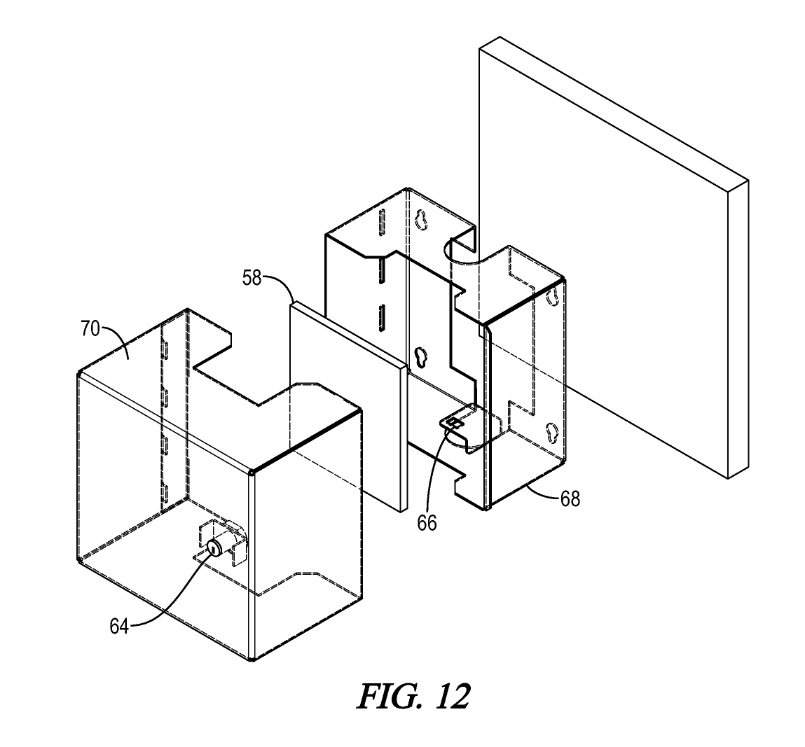

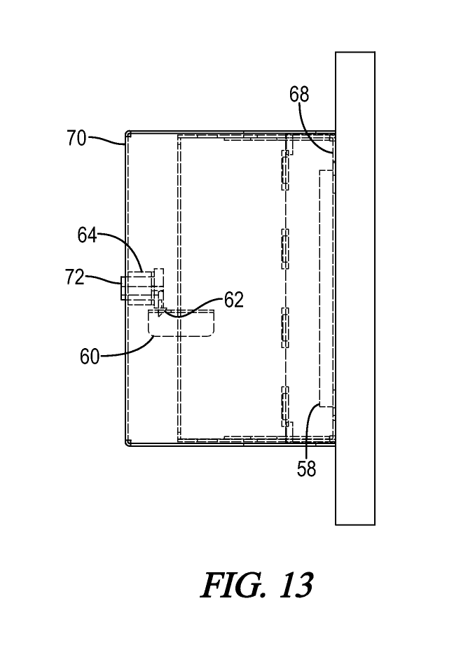

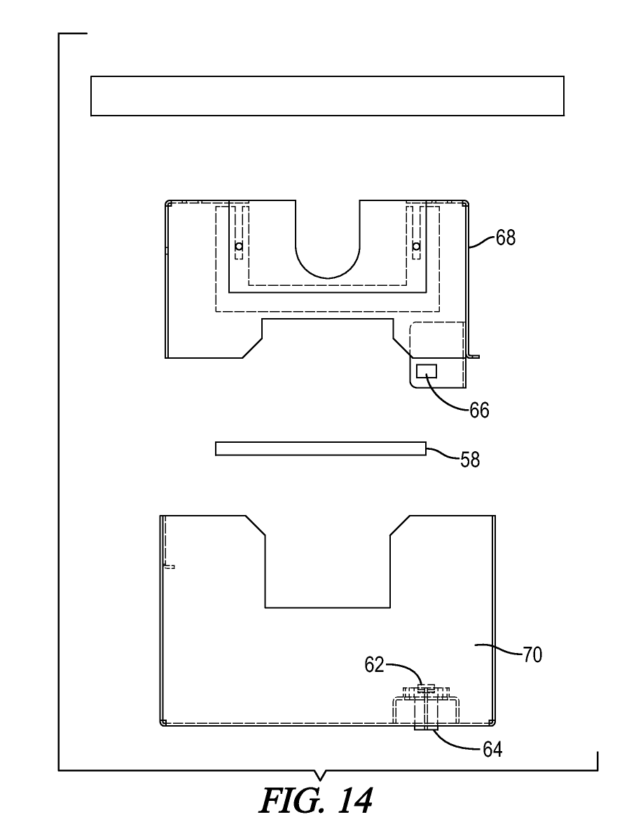

Referring now to FIGS. 12-14, an alternative embodiment of the present invention is shown FIG. 12 is an isometric view of an embodiment of the present invention with the second locking mechanism 60 attached to the key lock cylinder 64. In this embodiment, both the first 72 and second 60 locking mechanisms are activated by the removal of the key lock cylinder 64. The second locking mechanism 60 is a preferably hook-shaped clamping protrusion 62 on the key lock cylinder 64 that engages a locking slot 66 on the back mounting assembly 68 when the key lock cylinder 64 is turned. When the key lock cylinder 64 is removed from the front cover 70, the protrusion 62 is disengaged from the slot 66. FIG. 13 is a side view and FIG. 14 is a top view of the embodiment of FIG. 12.

The embodiment of FIGS. 12-14 uses a preferably plywood tap mount 58 that is used to provide a mounting surface for a cable tap. The tap mount 58 fits over the existing cable tap mount and allows for the installation of the secure enclosure and, new tap with only very minimal interruption of cable services. The tap mount can also be used in connection with the embodiment of FIG. 1.

The embodiment of FIGS. 12-14 is less secure than the embodiment of the FIG. 1 in that both the first and second locking mechanisms are engaged and disengaged with a single action. However, in situations where security is not a primary concern, the alternative embodiment provides a very cost effective and reasonably secure enclosure that does not require a hinge.

It is to be understood that the present invention is not explicitly limited to the embodiment illustrated in the detailed description given above. Various changes and modifications may be made to Theft Deterrent Enclosure without departing from the spirit and scope of the invention as defined in the following claims.

What is claimed is:

1. A theft deterrent enclosure comprising:
a back mounting assembly having a locking slot;
a front cover having a lock opening;
a key lock cylinder mounted in said lock opening of said front cover such that said key lock cylinder blocks said lock opening when said key lock cylinder is in a locked position; and
a keyed interface mounted on said front cover such that said keyed interface can only be accessed through said lock opening when said key lock cylinder is removed from said lock opening;
a mounting clamp mounted on said front cover that is adapted to engage with said locking slot on said back mounting member by operating said keyed interface to secure said front cover to said back mounting assembly in a closed position;
wherein said theft deterrent enclosure can be opened from a locked position by engaging said key lock cylinder with a key, removing said key lock cylinder from said lock opening, inserting a security keyed tool adapted to engage said keyed interface through said lock opening and disengaging said mounting clamp from said locking slot.

2. The theft deterrent enclosure of claim 1 further comprising a pair of protrusions on said front cover that engage a pair of mating slots on a back mounting assembly of said enclosure.

3. The theft deterrent enclosure of claim 1 wherein said keyed interface further comprises a threaded shaft with a security keyed screw head.

4. The theft deterrent enclosure of claim 1 further comprising a sleeve guide positioned inside said enclosure that guides a security keyed tool toward said keyed interface.

5. The theft deterrent enclosure of claim 1 wherein said keyed interface is positioned on an interior of said enclosure opposite and aligned with said lock opening.

6. The theft deterrent enclosure of claim 1 wherein said theft deterrent enclosure does not have a hinge.

7. A theft deterrent enclosure comprising:
a housing comprising a front cover and a back mounting assembly;
a first locking mechanism mounted in a lock opening on said front cover such that said first lock mechanism blocks said lock opening wherein said first lock mechanism can be removed from said opening using a key that mates with said first lock mechanism; and
a second locking mechanism comprising a mounting clamp that engages a locking slot wherein said second locking mechanism can be engaged with a security keyed tool inserted through said lock opening only when said first locking mechanism is removed from said lock opening.

8. The theft deterrent enclosure of claim 7 wherein said theft deterrent enclosure does not have a hinge.

9. The theft deterrent enclosure of claim 7 further comprising a pair of protrusions on said front cover that engage a pair of mating slots on said back mounting assembly.

10. The theft deterrent enclosure of claim 7 wherein said second locking mechanism comprises a threaded shaft with a security keyed screw head.

11. The theft deterrent enclosure of claim 7 further comprising a sleeve guide positioned inside said theft deterrent enclosure that guides said security keyed tool toward said second locking mechanism.

12. The theft deterrent enclosure of claim 7 wherein said second locking mechanism is positioned on an interior of said enclosure opposite and aligned with said lock opening.

13. The theft deterrent enclosure of claim 7 wherein said first locking mechanism further comprising a key lock cylinder having a removable tumbler.

14. An enclosure comprising:
a first lock mechanism mounted in a lock opening of a front cover of said enclosure such that said lock mechanism blocks said lock opening when said first lock mechanism is locked; and
a second lock mechanism comprising a protrusion attached to said first lock mechanism that mates with a locking slot on a back mounting assembly to hold said enclosure in a closed position wherein said second lock mechanism is engaged and disengaged by operating said first lock mechanism.

15. The enclosure of claim 14 wherein said first lock mechanism further comprises a key lock cylinder with a removable tumbler.

16. The enclosure of claim 14 further comprising a pair of protrusions on said front cover that engage a pair of mating slots on a back mounting assembly of said enclosure.

17. The enclosure of claim 14 wherein said enclosure does not have a hinge.

18. The enclosure of claim 14 wherein said protrusion is hook shaped.

19. The enclosure of claim 14 further comprising a tap mount.
